(19) United States
(12) Patent Application Publication
(10) Pub. No.: US 2003/0034424 A1
(43) Pub. Date: Feb. 20, 2003

(54) Duct supporting device

(76) Inventor: Gerald D. Collins, Claudville, VA (US)

Correspondence Address: Kaardal & Associates, PC, Attn: Ivar M. Kaardal, 3500 South First Ave. Circle-Suite 250, Sioux Falls, SD, 57105-5802, US

(21) Appl. No.: 09/732,580

(22) Filed: Dec. 8, 2000

(51) Int. Cl. F16L 3/00; E21F 17/02

(52) U.S. Cl. 248/59

(57) ABSTRACT

A duct supporting device for more easily hanging ducting throughout a structure. The duct supporting device includes a support member. The support member includes a first bar and a pair of upstanding bars. Each of the upstanding bars is integrally coupled to and extending outwardly from opposite ends of the first bar. The invention includes a pair of brackets for securing the support member to the pair of joists. Each of the brackets includes a base wall and a pair of side walls integrally coupled thereto and extending away therefrom in a generally parallel direction. A bottom surface of each of the base members is securably attached to one of a second end of the pair of upstanding members. Each of the side walls includes an opening extending therethrough. A plurality of securing means for releasably fastening each of the brackets to one of the joists. Each of the securing means is removably positionable in one of the openings of the pair of side walls of the brackets.

### BACKGROUND OF THE INVENTION

1. Field of the Invention

The present invention relates to supporting devices and more particularly pertains to a new duct supporting device for more easily hanging ducting throughout a structure.

2. Description of the Prior Art

The use of supporting devices is known in the prior art. More specifically, supporting devices heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. Nos. 4,077,592; 1,784,244; U.S. Pat. No. Des. 256,216; U.S. Pat. Nos. 5,039,039; 2,889,145; and 5,102,074.

While these devices fulfill their respective, particular objectives and requirements, the aforementioned patents do not disclose a new duct supporting device. The inventive device includes a support member. The support member includes a first bar and a pair of upstanding bars. Each of the upstanding bars is integrally coupled to and extending outwardly from opposite ends of the first bar. The invention includes a pair of brackets for securing the support member to the pair of joists. Each of the brackets includes a base wall and a pair of side walls integrally coupled thereto and extending away therefrom in a generally parallel direction. A bottom surface of each of the base members is securably attached to one of a second end of the pair of upstanding members. Each of the side walls includes an opening extending therethrough. A plurality of securing means for releasably fastening each of the brackets to one of the joists. Each of the securing means is removably positionable in one of the openings of the pair of side walls of the brackets.

In these respects, the duct supporting device according to the present invention substantially departs from the conventional concepts and designs of the prior art, and in so doing provides an apparatus primarily developed for the purpose of more easily hanging ducting throughout a structure.

### SUMMARY OF THE INVENTION

In view of the foregoing disadvantages inherent in the known types of supporting devices now present in the prior art, the present invention provides a new duct supporting device construction wherein the same can be utilized for more easily hanging ducting throughout a structure.

The general purpose of the present invention, which will be described subsequently in greater detail, is to provide a new duct supporting device apparatus and method which has many of the advantages of the supporting devices mentioned heretofore and many novel features that result in a new duct supporting device which is not anticipated, rendered obvious, suggested, or even implied by any of the prior art supporting devices, either alone or in any combination thereof.

To attain this, the present invention generally comprises a support member. The support member includes a first bar and a pair of upstanding bars. Each of the upstanding bars is integrally coupled to and extending outwardly from opposite ends of the first bar. The invention includes a pair of brackets for securing the support member to the pair of joists. Each of the brackets includes a base wall and a pair of side walls integrally coupled thereto and extending away therefrom in a generally parallel direction. A bottom surface of each of the base members is securably attached to one of a second end of the pair of upstanding members. Each of the side walls includes an opening extending therethrough. A plurality of securing means for releasably fastening each of the brackets to one of the joists. Each of the securing means is removably positionable in one of the openings of the pair of side walls of the brackets.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new duct supporting device apparatus and method which has many of the advantages of the supporting devices mentioned heretofore and many novel features that result in a new duct supporting device which is not anticipated, rendered obvious, suggested, or even implied by any of the prior art supporting devices, either alone or in any combination thereof.

It is another object of the present invention to provide a new duct supporting device which may be easily and efficiently manufactured and marketed.

It is a further object of the present invention to provide a new duct supporting device which is of a durable and reliable construction.

An even further object of the present invention is to provide a new duct supporting device which is susceptible of a low cost of manufacture with regard to both materials and labor, and which accordingly is then susceptible of low prices of sale to the consuming public, thereby making such duct supporting device economically available to the buying public.

Still yet another object of the present invention is to provide a new duct supporting device which provides in the apparatuses and methods of the prior art some of the advantages thereof, while simultaneously overcoming some of the disadvantages normally associated therewith.

Still another object of the present invention is to provide a new duct supporting device for more easily hanging ducting throughout a structure.

Yet another object of the present invention is to provide a new duct supporting device which includes a support member. The support member includes a first bar and a pair of upstanding bars. Each of the upstanding bars is integrally coupled to and extending outwardly from opposite ends of the first bar. The invention includes a pair of brackets for securing the support member to the pair of joists. Each of the brackets includes a base wall and a pair of side walls integrally coupled thereto and extending away therefrom in a generally parallel direction. A bottom surface of each of the base members is securably attached to one of a second end of the pair of upstanding members. Each of the side walls includes an opening extending therethrough. A plurality of securing means for releasably fastening each of the brackets to one of the joists. Each of the securing means is removably positionable in one of the openings of the pair of side walls of the brackets.

Still yet another object of the present invention is to provide a new duct supporting device that reduces the number of individuals required for installing ducting. The present invention's lightweight and versatile design allows fewer individuals to install ducting.

Even still another object of the present invention is to provide a new duct supporting device that is versatile. The present invention's design allows it to be used for a wide variety of ducting projects. It allows a user to use the same supportive device regardless of the width or height of the ducting.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic perspective view of a new duct supporting device according to the present invention.

FIG. 2 is a schematic frontal view of the present invention.

FIG. 3 is a schematic cross-sectional view of the present invention taken along line 3-3.

### DESCRIPTION OF THE PREFERRED EMBODIMENT

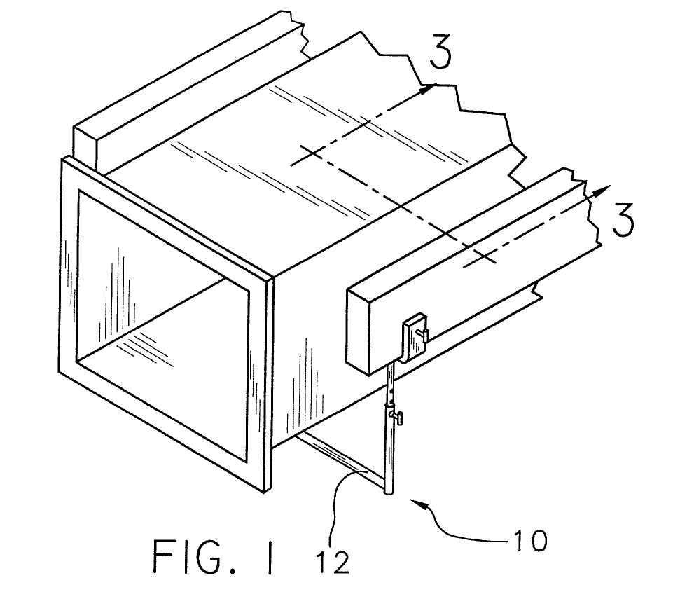

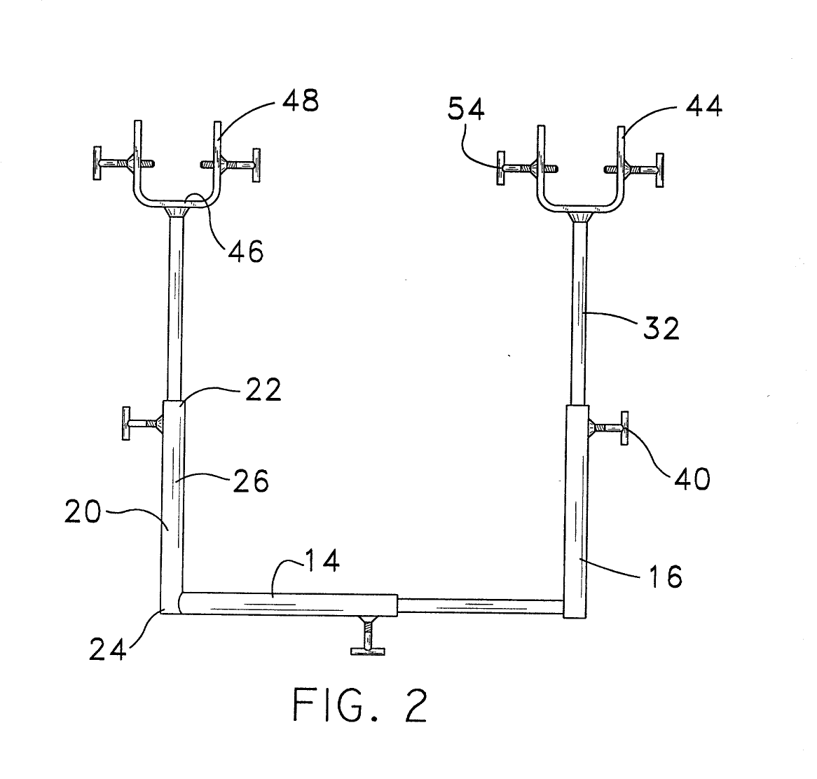

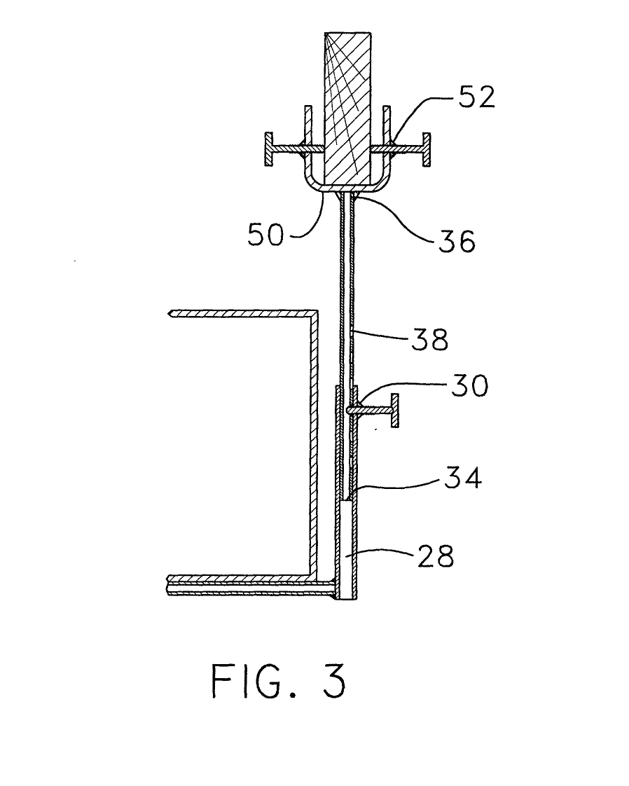

With reference now to the drawings, and in particular to FIGS. 1 through 3 thereof, a new duct supporting device embodying the principles and concepts of the present invention and generally designated by the reference numeral 10 will be described.

As best illustrated in FIGS. 1 through 3, the duct supporting device 10 generally comprises a support member 12. The support member 12 includes a first bar 14 and a pair of upstanding bars 16. Each of the upstanding bars 16 is integrally coupled to and extending outwardly from opposite ends of the first bar 14. Each of the upstanding bars 16 are orientated generally perpendicular to the first bar 14 and extend in a parallel direction to each other. The first bar 14 and the pair of upstanding bars 16 are attached such that the support member 12 has generally a u-shape.

Each of the bars comprises a first portion 20. The first portion 20 includes a first end 22, a second end 24 and a peripheral wall 26 extending therebetween. The first end 22 includes an opening 28 extending therethrough. The peripheral wall 26 of the first portion 20 includes an aperture 30 extending therein. The aperture 30 is positioned generally adjacent to the first end 22.

Each of the bars 14 and 15 also include a second portion 32. The second portion 32 includes a first end 34 and a second end 36. The first end 34 of the second portion 32 is extendably movable in the opening 28 of the first portion 20 such that the first portion 20 and the second portion 32 are selectively telescoping. The second portion 32 includes a plurality of aligned holes 38 extending therein. Each of the holes 38 is individually alignable with the aperture 30 of the first portion 20. The first portion 20 and the second portion 32 comprise a substantially rigid material such as aluminum or steel. The telescoping ability of the first and second portions 22 and 32 allows a user to adjust the height and width of the support member 12.

A fastening means 40 for releasably fastening the first portion 22 to the second portion 32. The fastening means 40 is removably extendable through the aperture 30 of the first portion 20 and into one of the holes 38 of the second portion 32. Each of the fastening means 40 comprises a screw. Other types of fasteners may also be used such as a pin.

There are a pair of brackets 44 for securing the support member 12 to the pair of joists. Each of the brackets 44 includes a base wall 46 and a pair of side walls 48 integrally coupled thereto and extending away therefrom in a generally parallel direction. A bottom surface 50 of the base wall 46 is securably attached to one of the second ends 36 of the pair of upstanding bars 16. Each of the side walls 48 is orientated generally perpendicular to the first bar 14 and extending away therefrom. Each of the side walls 48 includes an opening 52 extending therethrough. Each of the openings 52 is positioned generally between the base wall 46 and a free edge 56 of each of the side walls.

A plurality of securing means 54 for releasably fastening each of the brackets 44 to one of the joists. Each of the securing means 45 is removably positionable in one of the openings 52 of the pair of side walls 48 of the brackets 44 and abutting against a respective joist. Each of the securing means 54 comprises a screw.

In use, the first bar 14 and the pair of upstanding bars 16 are set to the proper width and height needed for the duct being installed. To set the width the user separates the first portion 20 from the second portion 32 and fastening the two together by the fastening means 40. To set the height the user separates the first portion 20 and the second portion 32 of each of the upstanding members 16 and fastening the two together by the fastening means. Once the support member 12 is ready the support member is secured to the joist by the securing means 54. The support member 12 thereby holds the duct in place. Depending on the length of ducting to be installed, a support member 12 may be installed at regular intervals throughout the entire length of ducting.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A duct supporting device, said device being adapted for supporting a duct to a pair of joists, said device comprising:
a support member, said support member having a first bar and a pair of upstanding bars, each of said upstanding bars being integrally coupled to and extending outwardly from opposite ends of said first bar;
a pair of brackets for securing said support member to the pair of joists, each of said brackets having a base wall and a pair of side walls integrally coupled thereto and extending away therefrom in a generally parallel direction, a bottom surface of each of said base members being securably attached to one of a second ends of said pair of upstanding members, each of said side walls having an opening extending therethrough; and
a plurality of securing means for releasably fastening each of said brackets to one of the joists, each of said securing means being removably positionable in one of said openings of said pair of side walls of said brackets.

2. The duct supporting device of claim 1 wherein said first bar further comprises:
said first bar comprising;
a first portion, said first portion having a first end, a second end and a peripheral wall extending therebetween, said first end having an opening extending therethrough; and
a second portion, said second portion having a first end and a second end, said first end of said second portion being extendably movable in said opening of said first portion such that said first portion and said second portion are selectively telescoping.

3. The duct supporting device of claim 2, wherein each of said portions further comprises:
said peripheral wall of said first portion having an aperture extending therein; and
said second portion having a plurality of aligned holes extending therein, each of said holes being individually alignable with said aperture of said first portion.

4. The duct supporting device of claim 3, further comprising:
a fastening means for releasably fastening said first portion to said second portion, said fastening means being removably extendable through said aperture of said first portion and into one of said holes of said second portion.

5. The duct supporting device of claim 1 wherein each of said upstanding bars further comprises:
each of said upstanding bars comprising;
a first portion, said first portion having a first end, a second end and a peripheral wall extending therebetween, said first end having an opening extending therethrough; and
a second portion, said second portion having a first end and a second end, said first end of said second portion being extendably movable in said opening of said first portion such that said first portion and said second portion are selectively telescoping.

6. The duct supporting device of claim 5, wherein each of said portions further comprises:
said peripheral wall of said first portion having an aperture extending therein; and
said second portion having a plurality of aligned holes extending therein, each of said holes being individually alignable with said aperture of said first portion.

7. The duct supporting device of claim 6, further comprising:
a fastening means for releasably fastening said first portion to said second portion, said fastening means being removably extendable through said aperture of said first portion and into one of said holes of said second portion.

8. The duct supporting device of claim 1, wherein each of said side wall of said brackets further comprises:
each of said side walls being orientated generally perpendicular to said first bar and extending away therefrom, each of said openings being positioned generally between said base wall and a free edge of each of said side walls.

9. A duct supporting device, said device being adapted for supporting a duct to a pair of joists, said device comprising:
a support member, said support member having a first bar and a pair of upstanding bars, each of said upstanding bars being integrally coupled to and extending outwardly from opposite ends of said first bar, each of said upstanding bars being orientated generally perpendicular to said first bar and extending in a parallel direction to each other, each of said bars comprising;
a first portion, said first portion having a first end, a second end and a peripheral wall extending therebetween, said first end having an opening extending therethrough, said peripheral wall of said first portion having an aperture extending therein, said aperture being positioned generally adjacent to said first end;
a second portion, said second portion having a first end and a second end, said first end of said second portion being extendably movable in said opening of said first portion such that said first portion and said second portion are selectively telescoping, said second portion having a plurality of aligned holes extending therein, each of said holes being individually alignable with said aperture of said first portion;
a fastening means for releasably fastening said first portion to said second portion, said fastening means being removably extendable through said aperture of said first portion and into one of said holes of said second portion, each of said fastening means comprising a screw;
a pair of brackets for securing said support member to the pair of joists, each of said brackets having a base wall and a pair of side walls integrally coupled thereto and extending away therefrom in a generally parallel direction, a bottom surface of each of said base members being securably attached to one of said second ends of said pair of upstanding members, each of said side walls being orientated generally perpendicular to said first bar and extending away therefrom, each of said side walls having an opening extending therethrough, each of said openings being positioned generally between said base wall and a free edge of each of said side walls; and
a plurality of securing means for releasably fastening each of said brackets to one of the joists, each of said securing means being removably positionable in one of said openings of said pair of side walls of said brackets and abutting against a respective joist, each of said securing means comprising a screw.
